(19) United States
(12) Patent Application Publication
(10) Pub. No.: US 2012/0105467 A1
(43) Pub. Date: May 3, 2012

(54) Image And Theme Artwork Management

(76) Inventors: Hui Chao, San Jose, CA (US); Xuemei Zhang, Mountain View, CA (US); Daniel R. Tretter, San Jose, CA (US); Nina Bhatti, Los Altos, CA (US)

(21) Appl. No.: 13/378,647

(22) PCT Filed: Jun. 15, 2009
(86) PCT No.: PCT/US09/47382

§ 371 Date: Dec. 15, 2011

(51) Int. Cl. G09G 5/02

(52) U.S. Cl. 345/589

(57) ABSTRACT

An image and theme artwork management method (98) for optimizing a presentation of images displayed in a design, in which each image comprises colors, content, and metadata, includes selecting an artwork theme (93) for the design as a function of the metadata of the images; and adjusting the colors of the artwork theme (94) as a function of the colors of the images such that the images and the artwork theme within the design comprise more complimentary, contrasting, or similar colors.

### BACKGROUND

Graphic designers, amateur photographers, average consumers, or individuals working in small or medium businesses with little or no graphics design training, have long been frustrated by the time and attention required to manually assemble compositionally consistent photographic images, backgrounds, captions, and related artwork within photo albums, brochures, catalogs, marketing materials, web pages, or other such materials. Designers manually select and adjust the colors and shapes of the elements within a graphic design consistent with a coherent theme. Additionally, designers will follow basic color design theory guidelines to achieve coherency. For example, the graphic design creation process may include selecting or adjusting graphic design elements' colors based on complementary colors or shades consistent with the desired theme.

This method is usually effective when dealing with a single, uncomplicated photograph on a single page as a graphic designer can easily select colors and shapes consistent with the content of a single photograph. However, generating a consistent design theme that matches photographic content can be more difficult when selecting a color design theme from a single, complex photograph, or assembling several photographs on a single page that vary significantly in image color or tones. For example, matching photographic content by selecting the average color of all the photographs may degenerate the thematic color scheme into a gray shade, as only gray can be considered compatible with each photograph's color or tone. Alternatively, a designer may manually adjust an individual photograph's color by changing its hue, saturation, and contrast to achieve greater harmonic color within a page.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is depiction of a color wheel, comprising ten hues.

FIG. 2A is a depiction of a Hue, Saturation, Light Color Model.

FIG. 2B is a depiction of a Hue, Saturation, Value Color Model.

FIG. 3A is a collection of photographic images, according to principles described herein.

FIG. 3B illustrates several groupings of photographic images, according to principles described herein.

FIG. 4A illustrates a grouping of photographic images, according to principles described herein.

FIG. 4B further illustrates a grouping of photographic images, according to principles described herein.

FIG. 5A illustrates various artwork themes, according to principles described herein.

FIG. 5B illustrates various thematic artwork elements, according to principles described herein.

FIG. 6A illustrates a collection of photographic images and a collection of thematic artwork elements, according to principles described herein.

FIG. 6B illustrates images grouped to opposing pages of a photo album, according to principles described herein.

FIG. 7A illustrates a photo book page, according to principles described herein.

FIG. 7B further illustrates a photo book page, according to principles described herein.

FIG. 8 is a diagram of an exemplary system for creating a graphic design, according to principles described herein.

FIG. 9 is a flowchart illustrating an exemplary method of creating a graphic design, according to principles described herein.

Throughout the drawings, identical reference numbers designate similar, but not necessarily identical, elements.

### DETAILED DESCRIPTION

This present specification describes methods and systems that optimize the presentation of photographic materials displayed in a design which may include thematic colors, backgrounds, artwork, captions, graphics, logos, text, etc. Typical collections may include photo albums, brochures, catalogs, web pages, or marketing materials. In the disclosed methods and systems, the interaction between photographic content and associated artwork is bi-directional, that is, the artwork and theme can be influenced by photographic content and the selection and placement of photos is in keeping with the aesthetic theme selected in the document.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

When designing a compilation of material with diagrams, text, graphics, logos, or photographs that are linked together with associated artwork, the overall design appearance across multiple pages and photos has a significant impact on user experience, requiring the graphic designer to more closely match the total design theme on each page with each photograph's colors and shapes. Therefore, creating a coherent theme across multiple pages becomes more difficult when a graphic designer includes in an album a larger number of photographs with greater discrepancies in color content or when a graphic designer combines several pages of diagrams, text, and logos without photographic content. A graphic designer working on a multiple-page document is not only restricted by matching image content from multiple photographs with thematic colors and shapes on a single page but across many images spanning multiple pages.

Beyond professional graphic designers, amateur photographers, average consumers, or individuals working in small or medium businesses with little or no graphics design training may wish to create graphic designs without the expense or resources of a professional graphic artist. As used herein, the term “graphic designer” or “designer” refers to anyone producing a graphic design. These individuals may not have sufficient training or the time necessary to create coherent-looking graphic designs that complement their photos or business. Their difficulty increases, as described above, when attempting to assemble multiple-image and multiple-page document designs.

Bi-directional, automatic color adjustment between a design's artwork and images to create a coherent theme in a multi-image or multi-page design has not previously been available. Color adjustment and selection between images and thematic artwork has been done manually. Given the variety of image color content within a photographic collection, generating a consistent design theme that fits the whole collection tends to degenerate the thematic color scheme into a gray shade. Also, previous color-selection techniques have not addressed a designer's color choices within a theme.

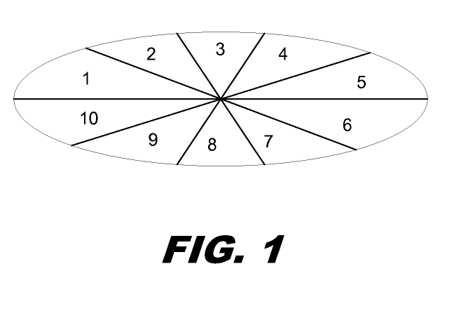

To create a graphic design, designers will manually assemble and adjust images (e.g., digital photographs, video frames, scanned documents, etc.), backgrounds, captions, and related artwork to be compositionally consistent within a coherent or harmonic theme. A coherent or harmonic theme refers to color combinations, or color schemes, that have been found to be pleasing to the human eye. Typically, the relationships of harmonic or contrasting colors are described in terms of their relative positions around a “color wheel,” which shows a set of colors arranged around the circumference of a circle. FIG. 1 illustrates a color wheel with ten colors. The colors on the color wheel are (moving clockwise) red 1, orange 2, yellow 3, yellow-green 4, green 5, blue-green 6, blue 7, blue-violet 8, violet 9, and red-violet 10. Complementary colors are located opposite each other on the color wheel (e.g., colors red 1 and blue-green 6 are complementary colors). Contrasting colors have three colors between them, i.e., red 1 and green 5 are contrasting colors. Similar colors are adjacent, i.e. red and orange are similar colors. Monochromatic colors are colors with the same hue but different tones, values, and saturation. Monochromatic colors are represented by a single color in the color wheel.

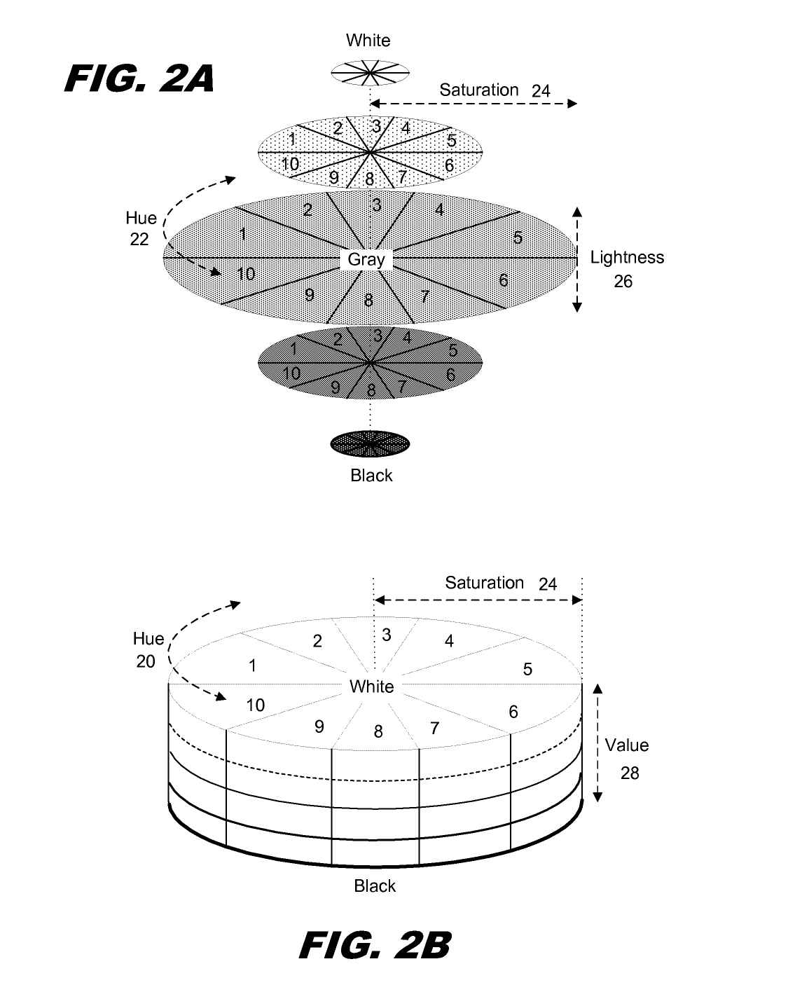

RGB is another color model that may be used to describe a color produced by adding the primary colors red, green, and blue. Additionally, HSL (hue, saturation, lightness) and HSV (hue, saturation, value) are two additional color models that describe color relationships perceptually. FIGS. 2A and 2B illustrate the HSL and HSV color models, respectively. Each model, as illustrated, includes ten colors. The colors on the models are the same as shown on the color wheel in FIG. 1. In the HSL or HSV model, color comprises hue, saturation, and lightness or value. Hue 22 is the actual color, or a color without tint or shade (added white or black pigment, respectively). The hue may be described as warm (red, orange, or yellow colors) or cool (green, blue, or violet colors). Saturation 24 refers to the vividness or intensity of the color and may be described as vibrant or dull. Lightness 26 in the HSL model, and similarly value 28, in the HSV model refers to the perceived reflectance of a surface, the shade of a color, or the amount of white or black mixed with a hue. The shade may be described as light or dark. On the top of both the HSL and HSV models, the shade is white. On the bottom of each model, the shade is black. In the middle of each model the shade is gray. Applying the HSL or HSV models, harmonic theme refers to combinations of colors with values of hue, saturation, and lightness or value that have been found to be pleasing to the human eye.

In creating a graphic design, designers will follow color design theory guidelines to achieve a harmonic theme. These guidelines may include selecting colors with appropriate values of hue, saturation, value, or lightness to achieve a certain mood (e.g. passion, tranquility, excitement, etc.), to communicate “energy” or to communicate a desired message. Another guideline may include adjusting the shading, i.e., the lightness value, before adjusting hue to create better color harmony, since changes in shading can have a more dramatic effect on mood and message.

Adjusting the hue, saturation, value, or lightness manually to achieve a harmonic theme is usually effective when dealing with a single photograph on a single page as a graphic designer can easily modify color values and shapes consistent with the content of a single photograph. However, when assembling on a single page several different photographs that vary significantly in image color or tones, generating a consistent design theme that matches the content of each image can be more difficult. For example, matching image content by selecting the average color of all the images may degenerate the thematic color scheme into a gray shade, as only gray can be considered compatible with each image's color or tone. Alternatively, a designer may manually adjust each individual image by adjusting the colors within the image. The designer may modify a color's hue, saturation, and contrast (or lightness) to achieve greater harmony (or distinction) within a page. Manually adjusting images is usually an iterative and time-consuming process.

Consequently, a unique, bi-directional image and theme artwork management process is proposed by the present specification. This method helps to automate the visual-arts design process to quickly produce beautiful, consistent-looking materials, while automatically applying design guidelines. A feature of this method is a two-way interaction or inter-dependence between thematic design and images on a single page as well as images within a multiple-page graphic design. One embodiment adapts existing design color and ornaments to a photograph's color and content while maintaining the artist's thematic design intent. Using a bi-directional interaction approach to optimize both photographs and theme art provides greater design flexibility and creative expression.

An individual creating a graphic design may be a professional graphic artist, an employee in a small or medium-sized business with little or no graphic-arts training, or an end consumer. The graphic design may be a photo album, brochure, catalog, advertisement, web page, or other such graphic-arts materials.

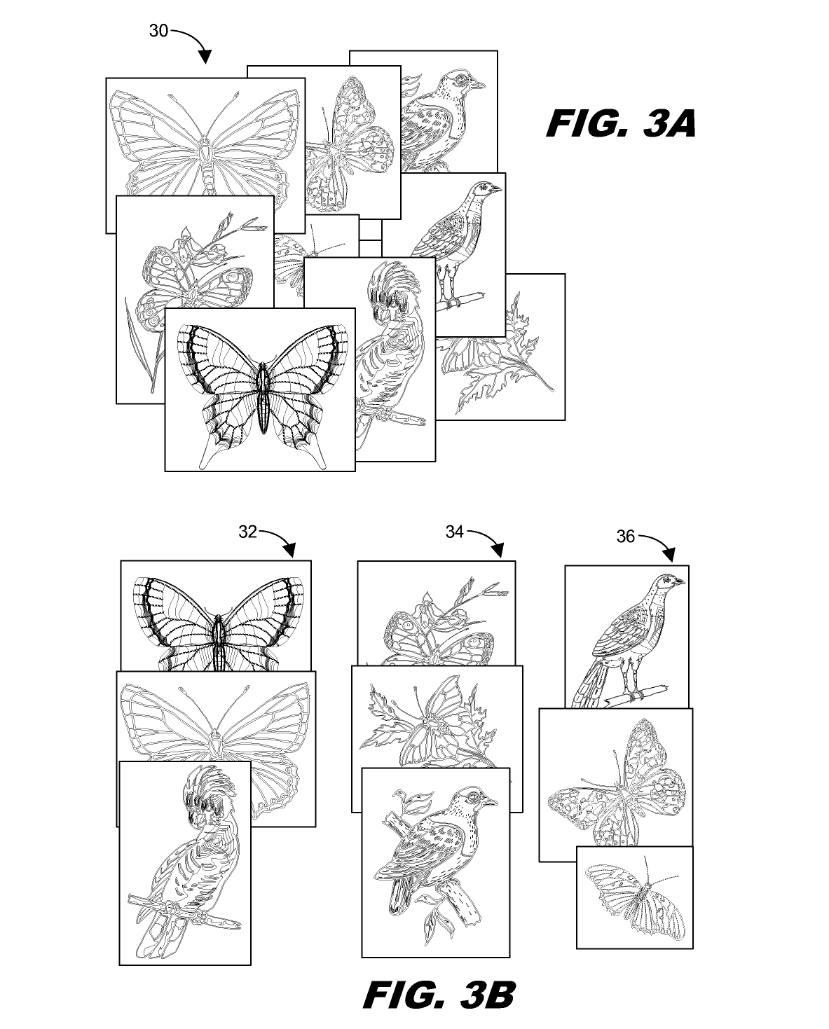

One step in creating a graphic design includes providing or selecting images to be displayed in the design. The images may include photographs, diagrams, drawings, text fonts, or design elements such as header and footer color blocks, frames, title bars, or graphics and may come from any source with varying degrees of quality. For example, the images may originate from personal or amateur photographic collections, stock or licensed images, drawing collections, or may be provided by a professional photographer. The images may include any type of subject matter or content, including, but not limited to, events, people, places, objects, or things. The content may include specific items or regions within an image. The image collection will typically include two or more images and may include hundreds of images depending on the size and scope of the design. Each image in the design will have its own content, colors, contrast, and metadata. For example, FIG. 3A illustrates a collection of images 30 of birds and butterflies.

Each image may have colors with varying hues, saturation, and lightness or value. The image may itself be, or include content that is, warm or cool, vibrant or dull, light or dark.

Each image may include its own metadata. Photographic metadata typically includes information concerning the date and time the photograph was taken as well as the camera settings (focal length, aperture, exposure, etc.) that the photographer used to take the photo. Metadata may also include labels, captions, annotations, or other information, describing image content, i.e. if the image contains elements such as grass, trees, sky, water, animals, or a human face. The metadata may also include information regarding image location, i.e., whether the photograph was taken “indoor” or “outdoor.” The metadata may also include information to indicate facial expressions, i.e. “face with a smile,” or the names of individuals appearing in a photograph. The metadata may also include quality ratings describing image contrast, resolution, or similar criteria. In each case, the metadata included with an image may be input manually or generated automatically by the camera used to take the photograph and/or through computer-aided image analysis algorithms or other such means.

Another step in creating a graphic design may include grouping the images into categories as a function of the colors, contrast or metadata of the images. A computer algorithm or designer may group images as a function of image colors, contrast, or metadata. Preferably, image grouping may be done automatically through a computer algorithm by analyzing the colors, contrast, or metadata of the images and comparing or contrasting image similarities and differences. Additionally, image grouping may include looking for reference categories describing content within the metadata and grouping the images as a function of the reference categories. After grouping, a designer may fine-tune or rearrange the images based on the designer's preferences. FIG. 3B illustrates image groupings 32, 24, and 36, from the image collection 30 depicted in FIG. 3A.

A designer or computer algorithm may further fine-tune categories by adjusting the colors and contrast of the images such that the images within one of the categories include consistent colors and contrast. As mentioned above, different images may vary significantly in image color or tones. This is especially true when the image collection includes very different subject matter between categories. For example, a designer may compile a product catalog or multiple-page advertisement with separate categories for clothing, house wares, and sports equipment. The images associated with these distinct categories may be very different in terms of their hues (warm or cold), saturation (vibrant or dull), and shade (dark or light). The designer's may wish to create a more consistent color scheme within each category. Therefore, instead of harmonizing the images across the entire design, the designer need only harmonize images within a specific category. A designer may also modify image coloring so as to emphasize an individual image or certain elements from an individual image.

A designer may automatically adjust individual images within a category to create a consistent color scheme without significant manual input. One such method may include a computer algorithm calculating the illumination point, or white point, of each image in a category, followed by balancing the illumination point to a similar, or consistent white point. Additionally, image adjustment may include a tone mapping process, or remapping the images' gray scales to create a consistent contrast among the images.

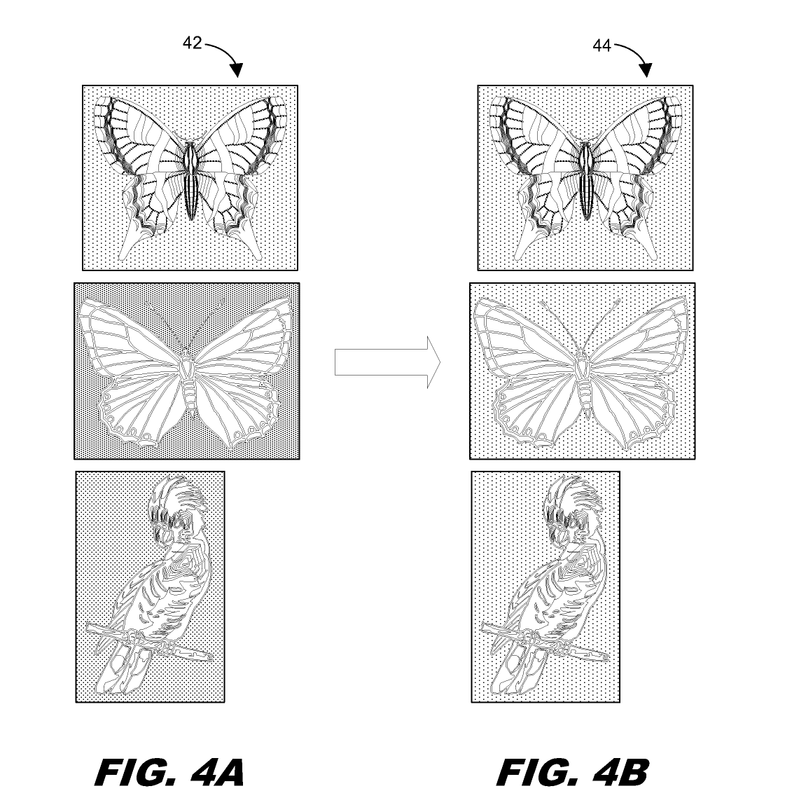

A designer may also color-match images by selecting a dominant or complimentary color and fine-tuning individual photographs to match the dominant or complementary color. The dominant or complimentary color may derive from the image's background, primary subject, or other image elements. FIGS. 4A and 4B illustrate background color adjustment within a category. The images 42 in FIG. 4A have slightly different background colors. The images 44 in FIG. 4B have matched color backgrounds. In addition to background color, a designer may also adjust the color of elements within the objects according to the processes or design objectives described above.

Color adjustments described above may be performed automatically through a computer algorithm. Automatic color adjustment may produce better or more consistent results than manual color adjustment. A designer may not arbitrarily adjust color content because the images must still look natural after any processing. When a computer algorithm adjusts color content, the algorithm may better preserve an image's natural look.

The consistency of a design is not just defined by color harmony. In many scenarios, themes are defined more by content than color. For example, design themes may include “summer vacation”, “family reunion” or “baby shower.” Therefore, a further step in creating a graphic design may include providing an artwork theme for the design as a function of image metadata. A computer algorithm may present a designer an artwork theme with labels or metadata semantically close to the existing image metadata. The designer may then select which theme more particularly matches the designer's images. In this manner, the selection and layout of design elements is adaptive to image content within the limits prescribed by the designer's choice of color schemes and graphic elements.

The artwork theme graphic elements may include thematic colors, backgrounds, borders, banners, text fonts, clip art, artwork, graphics, logos, or other such material. Each graphic element may have its own color and contrast as well as include properties of size, detail, line weight, fill-pattern, shadow, reflection or other similar properties. The artwork theme may contain its own metadata, similar to the image metadata described above. For example, the metadata describing the artwork theme may include labels, captions, or other annotations manually entered or automatically generated.

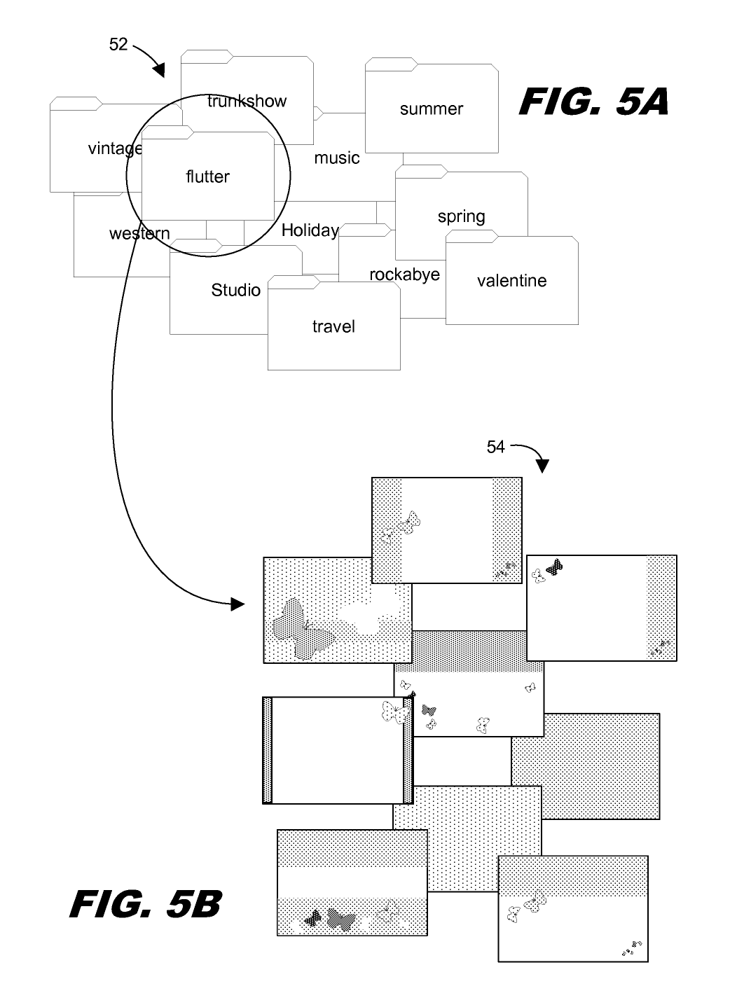

FIG. 5A illustrates various artwork themes 52 a computer algorithm may present a designer based on the images in the design. The artwork themes illustrated in this example include “summer,” “spring,” “valentine,” “flutter,” and various other categories. Each artwork theme “folder” may contain various thematic content elements consistent with the labeled “theme.” The artwork theme may include thematic content containing colors and contrast associated with the theme. FIG. 5B illustrates various thematic content elements 54 (borders, backgrounds, and clip art) that may be found in an artwork theme.

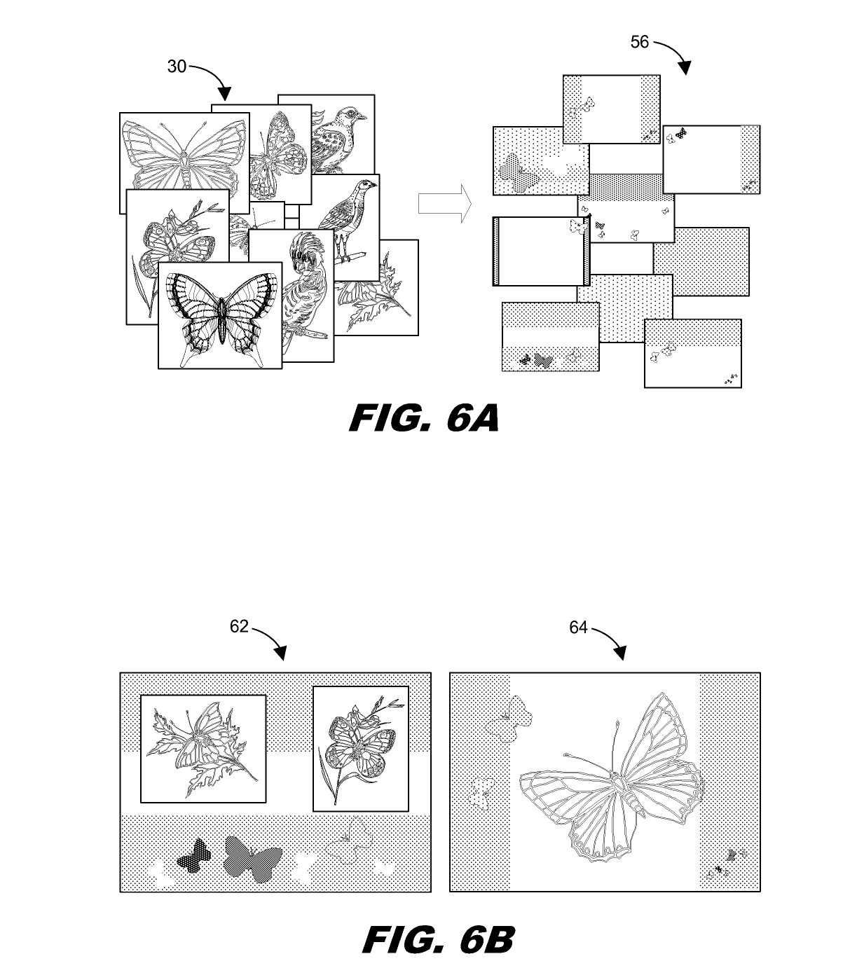

The various colors provided in the default artwork themes may or may not significantly match any image color contained within the entire design. Therefore, a further step in creating a design may include adjusting the colors of the artwork theme as a function of the colors of the images such that the images and the artwork theme within the design comprise more complimentary colors, more contrasting colors, or more similar colors. Referring back to the color wheel model in FIG. 1, the HSL model in FIG. 2A, and the HSV model in FIG. 2B, adjusting the colors of the images or artwork within a design comprises adjusting at least one of the color's hue, saturation, lightness (HSL) or value HSV). Therefore, to comprise more complementary colors includes adjusting the colors of the images or artwork such that the artwork colors and image content colors are more opposite each other on the color wheel. Similarly, adjusting images or artwork within a design to comprise more contrasting colors includes adjusting the colors of the images or artwork such that the artwork colors and image content colors, as illustrated on the color wheel, have three colors between them. Additionally, adjusting images or artwork within a design to comprise more similar colors includes adjusting the colors of the images or artwork such that the artwork colors and image content colors are more adjacent each other on the color wheel. For multiple-page designs, this step likely includes a color-alignment analysis across many pages, incorporating many (two or more) or all of the images in the design. At a book or collection level, a computer algorithm may analyze the color histogram of each image within the entire collection, measure the shortest color distance between the dominant color in an image color histogram and the artwork theme color histogram and select an artwork color theme with the shortest color distance. FIG. 6A illustrates a collection of images 30 and thematic content elements 56. A computer algorithm has adjusted the thematic content elements' colors through the process described above.

Each artwork thematic content element, i.e., a border, font, or graphic, may have its own color and contrast consistent with the design theme. The thematic content colors may subdue or highlight image content. A designer or computer algorithm may fine-tune the colors and contrast of each element contained in the thematic artwork to subdue or highlight specific image content. For example, artwork theme background or border colors may highlight certain aspects of individual images. Likewise, font colors or other artwork theme content colors may correspond to image elements the designer wishes to highlight or subdue.

Adjusting the colors and contrast of the artwork theme for an entire design includes evaluating images across the entire design as opposed to evaluating a single image displayed on one page. Algorithm-based single-image analysis typically compares the average color of the image with the average color of one, or a few, thematic elements. This process works well in selecting thematic colors associated with a single image. However, applying this method across multiple images typically degenerates the thematic color scheme into a gray shade, as only gray can be considered compatible with each image's color or tone. In contrast to the single-image analysis, a multiple-image analysis may evaluate the dominant or complimentary color appearing in multiple images.

A computer algorithm may apply several criteria to select or adjust artwork theme colors consistent across a multiple-image, multiple-page design. As mentioned above, one condition may be that selected colors appear in multiple images. Another requirement may be that the color must have a certain saturation level or have a similar saturation appearing in multiple images. A further constraint may be that the selected color not be gray. An additional method in determining artwork color may be to select a second or tertiary color that is not harmonious or contrasts with image color content and is selected to highlight or emphasize certain elements or image content from various images or to communicate a certain mood or message.

Yet another method to select the artwork theme colors is through matching artwork theme semantics with image semantics. For example, if the design illustrates children, the thematic colors may include bright primary colors or high-contrast designs. Or, if the display illustrates packaging for perfume or make-up, the designer may select black, white, or gold. In each instance, the colors within the thematic artwork may call attention to a certain feature or help bring focus to an area the designer wishes to accentuate. For example, the font colors can be selected to “pop” a focal point out of an image or to be in harmony with the image. The color may also be automatically selected for lettering that appears on the images or on the background. Additionally, the color histogram can be used to calculate font color automatically by selecting a color that appears in the histogram.

After the designer has selected the artwork color and themes, the designer or computer algorithm may then group the images into pages as a function of the colors and contrast of the images such that the images and the artwork theme within one of the pages comprise consistent colors and contrast. This step allows the designer to further fine-tune thematic colors to more closely match individual images. If the designer is creating a photo-book album, matching images and artwork may be selected that will appear on opposing pages. One method for performing this step is to measure the distance between the color histogram of the images and artwork that may be shown on the same page, or opposing pages, and grouping images to pages based on the shortest measured distances. FIG. 6B illustrates images grouped to opposing pages, 62 and 64, in a photo album.

Like the previous process steps, a computer algorithm or a designer may apply several criteria to select consistent artwork theme colors and images displayed on a single page or opposing pages. One requirement may be to avoid near color-matches between image-border colors and background colors. Another may be to avoid background colors that clash with image-border colors. Yet another criteria may be to select a color that provides significant contrast between image-border colors and background colors. Again like the previous step, the colors within the thematic artwork may call attention to a certain feature: font colors may highlight an image focal point or may be in harmony with the image. Similar to the previous step, a computer algorithm may automatically select and present to the designer specific thematic colors on an individual page consistent with lettering or background that appears in the images.

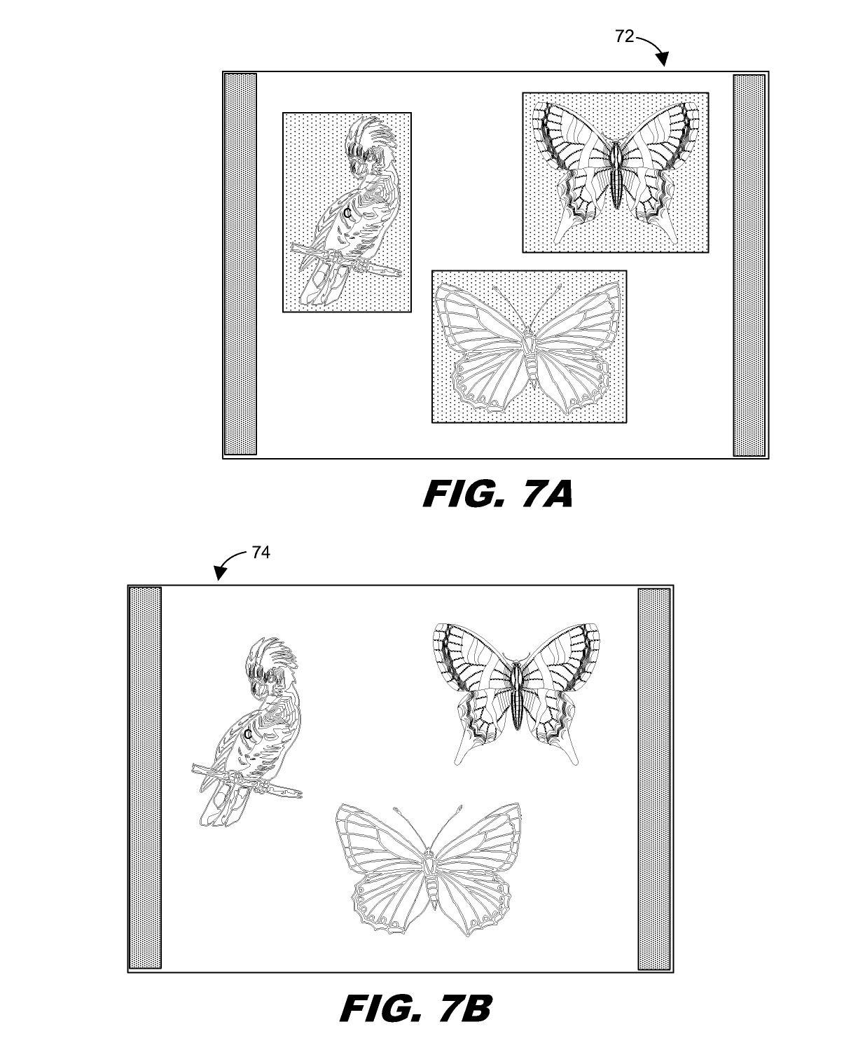

It is sometimes not possible to achieve an optimal look due to large discrepancies between individual image content and design theme. Therefore, a further step a designer or computer algorithm might perform to stay within design constraints while optimizing individual pages and images includes adjusting the colors and contrast of the images within a single page such that the images within a single page comprise consistent colors and contrast. In previous steps, a designer or a computer algorithm adjusted artwork theme colors and contrast to match image colors and contrast. In contrast to the previous steps, a designer or algorithm in this step adjusts image colors and contrast to match artwork theme colors and contrast on an individual page, creating a bi-directional influence between image color and artwork theme color. FIGS. 7A and 7B illustrate photo book pages 72 and 74. A computer algorithm has adjusted the background image colors in photo book 72 to more closely match the photo book background color. More typically, the colors within the image contents, and not the background, will be modified to more closely match thematic color elements.

A designer or algorithm faces several constraints in performing this step. Image colors should remain as natural as possible when modified from the original. One way to achieve this is to use natural lighting adaption models to modify color and avoid free editing by the designer. Skin tones and memory colors should also remain accurate, and any digital noise and artifacts in the image should not be overly exaggerated as a consequence of color and tone adjustments.

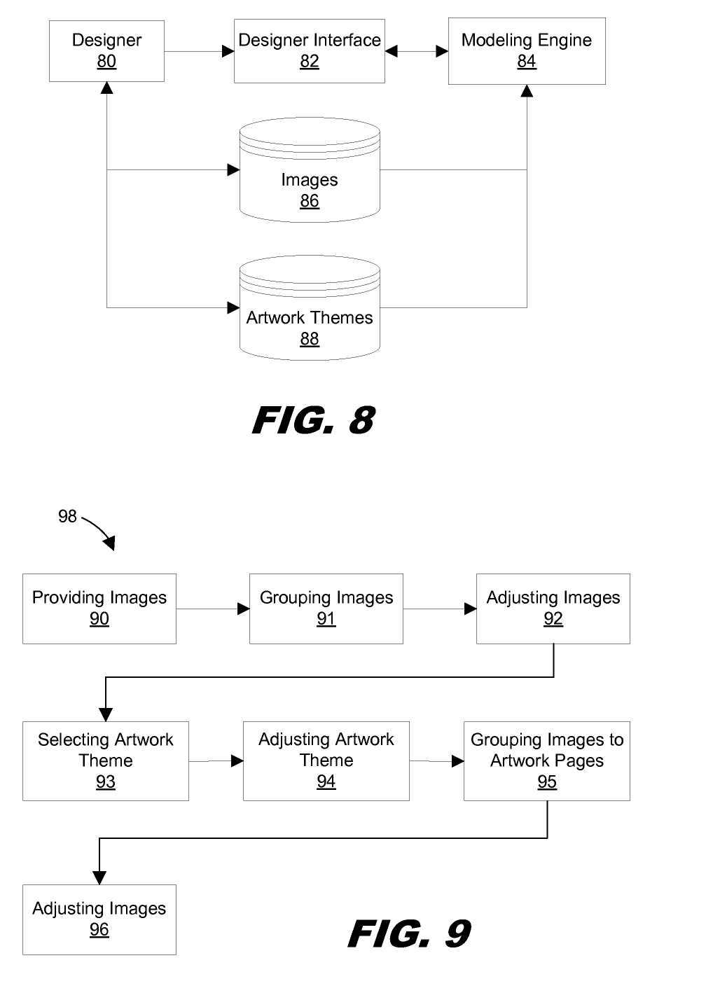

FIG. 8 illustrates a typical system that may be used to implement the processes described above. A designer 80 provides images 86 and artwork themes 88 to a database. The images and artwork themes contain colors, contrast, and metadata as described above. A modeling engine 84, containing the algorithms or instructions to optimize a presentation of images displayed in a design, evaluates and compares the colors, contrast and metadata of the images as described in the process steps above. The modeling engine 84 provides, through the designer interface 82, the selected and modified images and artwork themes necessary for the designer 80 to complete and fine-tune the design. The modeling engine 84 and the databases containing the images 86 and the artwork themes 88 may be a general-purpose computer. The algorithms or instructions for the modeling engine may be stored on a hard drive, in flash memory, or on an optical disc.

FIG. 9 illustrates a design process 98, including all the process steps illustrated above. A designer provides images 90 to be displayed in the design. A computer algorithm or a designer groups the images 91 into categories as a function of the colors, contrast or metadata of the images. Additionally, a designer or computer algorithm adjusts 92 the colors and contrast of the images such that the images within one of the categories include consistent colors and contrast. A designer or computer algorithm further provides or selects an artwork theme 93 for the design as a function of image metadata. Another step provides that the designer or a computer algorithm adjust the colors and contrast of the artwork theme 94 as a function of the colors and contrast of the images such that the images and the artwork theme within the design comprise consistent colors and contrast. In addition, a designer or computer algorithm groups the images into pages 95 as a function of the colors and contrast of the images such that the images and the artwork theme within one of the pages comprise consistent colors and contrast. As an additional step, a designer or computer algorithm adjusts the colors and contrast of the images 96 within a single page such that the images within a single page comprise consistent colors and contrast.

The preceding description has been presented only to illustrate and describe embodiments and examples of the principles described. This description is not intended to be exhaustive or to limit these principles to any precise form disclosed. Many modifications and variations are possible in light of the above teaching.

1. An artwork management method for optimizing a presentation of images displayed in a design, the method comprising:
selecting images comprising content, colors, and metadata;
selecting an artwork theme for the design, the artwork theme comprising content, colors, and metadata; and
adjusting the colors of the artwork theme as a function of the colors of the images such that at least one of the following occurs:
the images and the artwork theme comprise more complimentary colors;
the images and the artwork comprise more contrasting colors; and
the images and the artwork comprise more similar colors.

2. The method of claim 1, wherein the selecting the artwork theme comprises selecting the artwork theme as a function of at least one of the following:
the content of at least one image; and
the metadata of at least one image.

3. The method of claim 1, further comprising:
grouping the images into categories as a function of the colors, content or metadata of the images.

4. The method of claim 3, further comprising: adjusting the colors of the images such that at least one of the following occurs:
the images within one of the categories comprise more complimentary colors;
the images within one of the categories comprise more contrasting colors; and
the images within one of the categories comprise more similar colors.

5. The method of claim 1, wherein the adjusting the colors of the artwork theme further comprises:
analyzing a color histogram of each image to be displayed in the design;
analyzing a color histogram of each artwork theme color to be displayed in the design;
measuring a color distance between a dominant color in the image color histogram and the artwork theme color histogram; and
adjusting the colors of the artwork theme such that the artwork theme color histogram has a shorter color distance between a dominant color in the image color histogram and the artwork theme color histogram.

6. The method of claim 1, further comprising;
grouping the images into pages as a function of the colors of the images such that at least one of the following occurs:
the images and the artwork theme within one of the pages comprise more complimentary colors;
the images and the artwork theme within one of the pages comprise more contrasting colors; and
the images and the artwork theme within one of the pages comprise more similar colors.

7. The method of claim 1, further comprising:
adjusting the colors and contrast of the images such that at least one of the following occurs:
the images within one of the pages comprise more complimentary colors; and
the images within one of the pages comprise more similar colors.

8. The method of claim 1, further comprising:
adjusting the colors and contrast of the images through natural lighting adaption models.

9. A machine-readable medium storing machine-readable instructions causing a machine to optimize a presentation of images displayed in a design, the instructions comprising:
selecting images comprising content, colors, and metadata;
selecting an artwork theme for the design, wherein the artwork theme comprising colors, content, and metadata;
adjusting the colors of the artwork theme as a function of the colors of the images such that at least one of the following occurs:
the images and the artwork theme within the design comprise more complimentary colors;
the images and the artwork comprise more contrasting colors; and
the images and the artwork comprise more similar colors.

10. The machine-readable medium of claim 9, wherein the selecting the artwork theme comprises selecting the artwork theme as a function of at least one of the following:
the content of at least one image; and
the metadata of at least one image.

11. The machine-readable medium of claim 9, wherein the instructions further comprise:
grouping the images into categories as a function of the colors, content or metadata of the images.

12. The machine-readable medium of claim 9, wherein the instructions further comprise:
adjusting the colors of the images such that at least one of the following occurs:
the images within one of the categories comprise more complimentary colors;
the images within one of the categories comprise more contrasting colors; and
the images within one of the categories comprise more similar colors.

13. The machine-readable medium of claim 9, wherein the instructions further comprise:
analyzing a color histogram of each image to be displayed in the design;
analyzing a color histogram of each artwork theme color to be displayed in the design;
measuring a color distance between a dominant color in the image histogram and the artwork theme histogram; and
adjusting the colors of the artwork theme such that the artwork theme color histogram has a shorter color distance between a dominant color in the image color histogram and the artwork theme color histogram.

14. The machine-readable medium of claim 9, wherein the instructions further comprise:
grouping the images into pages as a function of the colors of the images such that at least one of the following occurs:
the images and the artwork theme within one of the pages comprise more complimentary colors;
the images and the artwork theme within one of the pages comprise more contrasting colors; and
the images and the artwork theme within one of the pages comprise more similar colors.

15. The machine-readable medium of claim 9, wherein the instructions further comprise:
adjusting the colors of the images that at least one of the following occurs:
the images within one of the pages comprise more complimentary colors; and
the images within one of the pages comprise more similar colors.
